(19) United States
(12) Patent Application Publication
(10) Pub. No.: US 2009/0175255 A1
(43) Pub. Date: Jul. 9, 2009

(54) WIRELESS TERMINAL AND BASE STATION DEVICES FOR MULTI-HOP COMMUNICATION

(75) Inventors: Hiroyuki AKIYAMA, Tokyo (JP); Hideaki ODAGIRI, Tokyo (JP)

Correspondence Address: Studebaker & Brackett PC, 1890 Preston White Drive, Suite 105, Reston, VA, 20191, US

(73) Assignee: OKI SEMICONDUCTOR CO., LTD., Tokyo (JP)

(21) Appl. No.: 12/349,603

(22) Filed: Jan. 7, 2009

(30) Foreign Application Priority Data
Jan. 9, 2008 (JP) 2008-002200

(51) Int. Cl. H04W 88/02

(52) U.S. Cl. 370/338

(57) ABSTRACT

A wireless terminal device and a wireless base station device can reduce power consumption required to transmit or receive data in a wireless manner. A frame sent from a wireless LAN terminal station, transfer source, is sent to another wireless LAN terminal station, transfer destination, on a transfer route indicated by routing information stored in a memory to establish a multi-hop communication with a wireless LAN base station.

### BACKGROUND OF THE INVENTION

1. Field of the Invention

The present invention relates to a wireless terminal device and a wireless base station device, more specifically to such devices transferring data sequentially along a plurality of adjacent wireless terminal devices for multi-hop communication with wireless base stations.

2. Description of the Background Art

In a telecommunications network, such as wireless LAN (Local Area Network), which transmits and receives data to and from base stations in a wireless manner, communication is established within an available range of radio waves transmitted from a wireless LAN base station, and the wireless LAN terminal stations existing in the range can transmit and receive a communication frame directly to and from the wireless LAN base station for thereby establishing communication. In the context, an available range in which radio waves transmitted from a wireless LAN base station or stations is referred to as a wireless network.

Specifically, a wireless network such as wireless LAN popularly adopts a wireless access scheme called CSMA/CA (Carrier Sense Multiple Access/Collision Avoidance). It takes a system or rule in which a wireless bandwidth of one and the same frequency is shared by a wireless LAN base station and all wireless LAN terminal stations that belong to the wireless network. Thus, in a wireless network using a wireless LAN, what can send frames simultaneously is limited to either the wireless LAN base station or one of the wireless LAN terminal stations.

Considering the receive power, every station in a wireless LAN communication always receives all frames transmitted on a wireless network while determining whether those frames are addressed to that station, i.e. own station or other stations. For that aim, an entire frame from its frame heading to its frame end has to be received to check an FCS (Frame Check Sequence), which is a frame error detection sequence by CRC (Cyclic Redundancy Check code) calculation. Of course, preceding the FCS check, also required are the conversion of a high-frequency reception radio wave to a baseband signal, analog-to-digital conversion, frame synchronization and demodulation. These processes consume a significant amount of electric power.

That causes, even for frames addressed to other stations, FCS check to be required, thus a further amount of electric power also being consumed. Consequently, the more frames are transmitted over a wireless network, the more power is consumed for the receive processing. This becomes a problem concerning the receive power consumption in a wireless network centering a wireless LAN base station.

As a background art, for example, Japanese patent laid-open publication No. 2007-104629 disclosed a technology, in a condition where both a wireless WAN (Wide Area Network) system accessing a wireless WAN base station and a wireless LAN system accessing a wireless LAN base station are collocated, a wireless terminal device uses, depending on the wireless communication condition, both the wireless WAN system and the wireless LAN system based multi-hop wireless transmission for communication.

This technology thus enables a wireless terminal device residing outside the available range of radio waves transmitted from the wireless LAN base station to perform a multi-hop communication with another wireless terminal device residing in that available range. However, the Japanese '629 publication is silent about a mechanism in which a wireless terminal device residing in the available range of radio waves transmitted from a wireless LAN base station and a wireless LAN base station communicate with each other via another wireless terminal device staying within the above-mentioned range.

### SUMMARY OF THE INVENTION

It is therefore an object of the present invention to provide such a wireless terminal device and a wireless base station device that their power consumption can be reduced as required to send/receive data in a wireless manner.

In accordance with the present invention, a wireless terminal device comprises: a memory for storing routing information on a transfer route for multi-hop communication with a communication target wireless base station and transmitted in a wireless manner from the wireless base station by sequentially transferring data between a plurality of adjacent wireless terminal devices belonging to a receivable range of a control frame containing control information for wireless communication with the wireless base station; a receiver for receiving a frame sent from the wireless base station and another wireless terminal device in the wireless manner; and a transmitter for sending first one of the frames received by said receiver on the transfer route indicated by the routing information stored by said memory to a transfer destination, the first frame being sent from the wireless terminal device operative as a transfer source.

In an aspect of the present invention, the memory stores routing information, sent in a wireless manner from a communication target wireless base station and indicating a transfer route for multi-hop communication with the wireless base station by sequentially transfer ring data between a plurality of adjacent wireless terminal devices residing within a receivable range of a specific control frame containing control information for wireless communication with the wireless base station.

Further in an aspect of the present invention, one of the frames received in a wireless manner from the wireless base station and another wireless terminal device is sent from the wireless terminal device operative as a transfer source on the transfer route indicated by the routing information stored in the memory to a transfer destination.

As described above, in accordance to the present invention, on the transfer route indicated by the routing information, a frame from the transfer source of the wireless terminal device is sent to a transfer destination on multi-hop communication with a wireless base station, thereby reducing the power consumption as required to transmit or receive data in a wireless manner.

The wireless terminal device in accordance with the present invention may further comprise: a generator for generating a frame to be transmitted to the wireless base station or the other wireless terminal device, and an aggregation circuit for aggregating the generated frame to one of the frames received by the receiver, the one frame having the same address the frame generated by the generator. The transmitter may send the aggregate frame to the transfer destination.

The wireless terminal device in accordance with the present invention may further comprise a determiner for using the signal length of the frame received from the other wireless terminal device by receiver to determine whether or not there is any other wireless terminal device in the neighborhood, and the transmitter may increase the transmission power if the determiner determines that there is no other wireless terminal device in the neighborhood.

A wireless base station device according to the present invention comprises: a memory for storing routing information on a transfer route for multi-hop communication with said wireless base station and transmitted in a wireless manner by sequentially transferring data between a plurality of adjacent wireless terminal devices belonging to a receivable range of a control frame containing control information for wireless communication with said wireless base station; a receiver for receiving a frame sent in the wireless manner from the wireless terminal device; a communication circuit connected to a backbone network for transmitting or receiving data to or from the backbone network; and a transmitter for sending first one of the frames received by said receiver and via said communication circuit on the transfer route indicated by the routing information stored in said memory to a transfer destination, the first frame having an address of another wireless terminal device, the transfer destination including a wireless terminal device specified by the address.

In an aspect of the base station according to the present invention, the memory stores routing information, sent in a wireless manner and indicating the transfer route for multi-hop communication with the wireless base station by sequentially transferring data between a plurality of adjacent wireless terminal devices belonging to the receivable range of a control frame containing control information for wireless communication with the wireless base station.

In an aspect of the base station according to the present invention, one of the frames sent in a wireless manner from the wireless terminal device and received by the receiver and via the communication circuit from the backbone network to be stored in the memory, the one frame having its address to another wireless terminal device, is sent by the transmitter to the transfer destination of the wireless terminal device having the address on the transfer route indicated by the routing information.

Thus, according to the present invention, one of the frames sent in a wireless manner from the wireless terminal device and received from the backbone network, the one frame having its address to another wireless terminal device, is sent to the transfer destination wireless terminal device having the address on a transfer route indicated by the routing information stored in the memory in order to perform multi-hop communication with wireless base station, thereby reducing power consumption required for sending or receiving data in a wireless manner.

The present invention may further include an aggregation circuit for aggregating a plurality of frames sent on the same transfer route into an aggregate frame so that the transmitter may send the aggregate frame to a transfer destination.

The transmitter may directly send the aggregate frame to each wireless terminal device belonging to the transfer route of the transfer destination. The transmitter may directly send the aggregate frame on a broadcast or multicast frame transmission to each wireless terminal device belonging to the transfer route of the transfer destination.

According to the present invention, the aggregation circuit may combine a plurality of frames having the same address. Then, the transmitter may send the aggregate frame on a unicast frame to the transfer destination of the wireless terminal device.

As described above, according to the present invention, on a transfer route indicated by routing information, a frame sent from the transfer source of a wireless terminal device is sent to a transfer destination on multi-hop communication with a wireless base station, thus such a remarkable effect being achieved that power consumption is significantly reduced as required to send or receive data in a wireless manner.

### BRIEF DESCRIPTION OF THE DRAWINGS

The objects and features of the present invention will become more apparent from consideration of the following detailed description taken in conjunction with the accompanying drawings in which:

FIG. 1 schematically illustrates a wireless network configuration according to an illustrative embodiment of the present invention;

FIG. 2 is a schematic block diagram illustrating a general functional configuration of a communication interface section of a wireless LAN terminal station according to a first illustrative embodiment of the present invention;

FIG. 3 schematically illustrates a communication available range of a wireless LAN base station according to the first embodiment;

FIG. 4 schematically illustrates the communication available range of the wireless LAN terminal stations according to the first embodiment;

FIG. 5 schematically illustrates how communication proceeds over the wireless network according to the first embodiment;

FIG. 6 schematically illustrates how communication proceeds over the wireless network result according to a second embodiment of the present invention;

FIG. 7 illustrates a data structure example of an aggregate frame;

FIG. 8 illustrates another data structure example of aggregate frame;

FIG. 9 illustrates a frame transfer sequence for a case in which wireless LAN terminal stations send communication frames without aggregating them;

FIG. 10 illustrates a frame transfer sequence for a case where wireless LAN terminal stations according to the second embodiment aggregate frames to send them;

FIG. 11 schematically illustrates how communication proceeds over the wireless network according to the first embodiment;

FIG. 12 schematically illustrates how communication proceeds over a wireless network according to a third embodiment of the invention;

FIG. 13 schematically illustrates how wireless LAN terminal stations receive aggregate frames on the basis of a group address according to the third embodiment;

FIG. 14 illustrates a frame transfer sequence in case where the wireless LAN terminal station receives a unicast frame and a group address frame;

FIG. 15 illustrates a frame transfer sequence in a case where the wireless LAN terminal station aggregate frames to send them according to the third embodiment;

FIG. 16 schematically illustrates the communication available range of wireless LAN terminal stations according to a fourth embodiment;

FIG. 17 schematically illustrates the wireless network configuration centering a wireless LAN base station;

FIG. 18 illustrates an example of frame transfer sequence between a wireless LAN base station and a wireless LAN terminal station;

FIG. 19 schematically illustrating a positional relation between the wireless LAN base station and wireless LAN terminal station together with a transmission power required;

FIG. 20 illustrating a frame format used in a wireless LAN; and

FIG. 21 is a flow chart useful for understanding a receive process proceeding when a frame is received.

### DESCRIPTION OF THE PREFERRED EMBODIMENTS

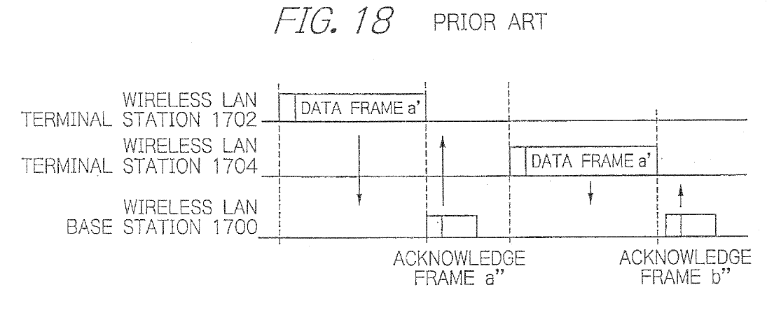

For better understanding of the present invention, reference will be made first to FIG. 17, which shows a conventional example of a network configuration having a wireless LAN base station 1700 centered. FIG. 18 shows an example frame transfer sequence between the wireless LAN base station 1700 and wireless LAN terminals 1702 and 1704. As shown in FIG. 17, a data frame 1710 is sent from the wireless LAN terminal station 1702 to the wireless LAN base station 1700, which in turn transmits to the wireless LAN terminal station 1702 an acknowledge frame 1712 indicating that it received the data frame 1710. From the wireless LAN terminal station 1704, a data frame 1714 is sent to the wireless LAN base station 1700, which in turn transmits to the wireless LAN terminal station 1702 an acknowledge frame 1714 indicating that it received the data frame 1714.

Thus in the prior art, in the wireless LAN based wireless network, what can simultaneously send a communication frame was restrictive to the wireless LAN base station 1700 or either one of the wireless LAN terminal stations 1702 and 1704.

The wireless LAN base station 1700 centered by the wireless network has generally powered from an external power supply, thus there being fewer restrictions on its power consumption while maintaining a higher transmission power. Consequently, in case of wireless LAN, a transmitted radio wave can reach about 100 meters. The thus broader available range of transmission radio waves, i.e. broader wireless network, is advantageous in, for example, preparing an infra structure available to a wireless LAN such as hot spot and having its wireless LAN base stations fewer, which means fewer wireless LAN base stations can cover broader service area, which is one of the very important features.

By contrast, the wireless LAN terminal stations 1702 and 1704 have a power frequently supplied from their internal power supply such as battery, needing to reduce power consumption as far as possible. For this purpose, the wireless LAN terminal stations 1702 and 1704 have to reduce power consumed when sending and receiving communication frames. For example, a reduction in transmission power of the stations would narrow the communication available range, degrading the usability. In addition, a reduction in receive power would not be so easy because all the frames received have to be processed to a certain extent, which ever they are addressed to the own station or other stations.

In other words, in the wireless network centering the wireless LAN base station 1700, such a transmission power is required that, for example, in a communication range of about 100 meters, the wireless LAN terminal stations 1702 and 1704 need to have its power supplied enough for transmitting frames on a radio wave that can reach the wireless LAN base station 1700. However, the wireless LAN terminal stations 1702 and 1704, when go away from the wireless LAN base station 1700, consume larger transmission power, causing the battery thereof rapidly exhaust themselves. This problem is involved with the transmission power consumption of wireless networks centering a wireless LAN base station, such as 1700.

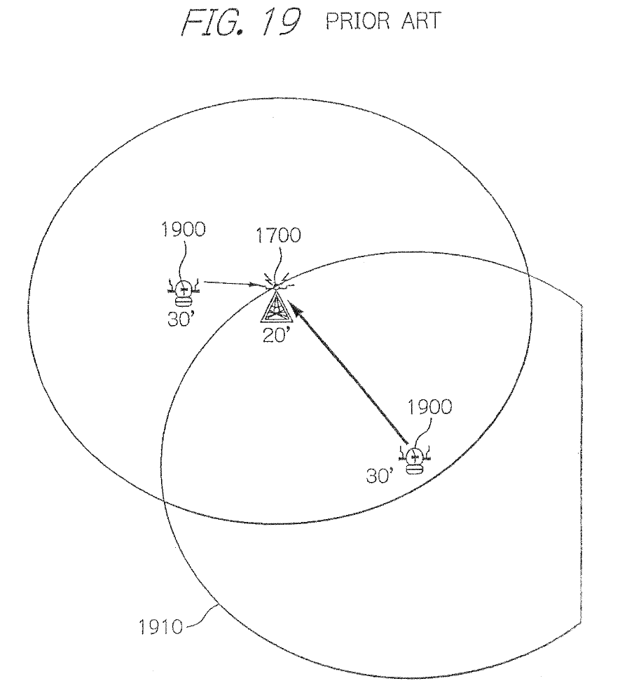

FIG. 19 shows a positional relation between the wireless LAN base station 1700 and wireless LAN terminal station 1900 together with transmission power required for frame transmission. In the figure, the thicker arrow represents the larger transmission power, and vice versa. In one of the possible solutions to the problem of rapid transmission power consumption, the wireless LAN terminal station 1900 could minimize its transmission power to its possible extent by controlling the transmission power to such a minimal value that the wireless LAN base station 1700 can receive the radio wave. This method however would weaken a radio wave due to the reduced transmission power, causing the base station to be more susceptible to the effect of peripheral noise. Thus, it would often cause a frame retransmission, rendering the quality of communication to be deteriorated, so that the advantage of lower power consumption cannot be expected.

In another possible solution, in addition to limiting the transmission power, reduction in communication rate would reduce the effect of peripheral noise by adopting a modulation scheme with its noise resistance harder. This method would reduce the communication rate indeed, but the period of time required for transmission would be longer accordingly so as to cancel the total effect of power consumption reduction.

Now, considering the receive power, the conventional wireless LAN communication needs to receive a frame from its heading to end in order to derive an FCS (Frame Check Sequence) As stated earlier, preceding the FCS check, also required are the baseband frequency conversion, analog-to-digital conversion, frame synchronization and demodulation, consuming a remarkable amount of electric power.

That causes, even for frames addressed to other stations, FCS check to be required, thus consuming a further amount of electric power. Consequently, the more frames are transmitted over a wireless network, the more power is consumed for the receive processing. This problem is involved with receive power consumption in a wireless network centering the wireless LAN base station, such as 1700.

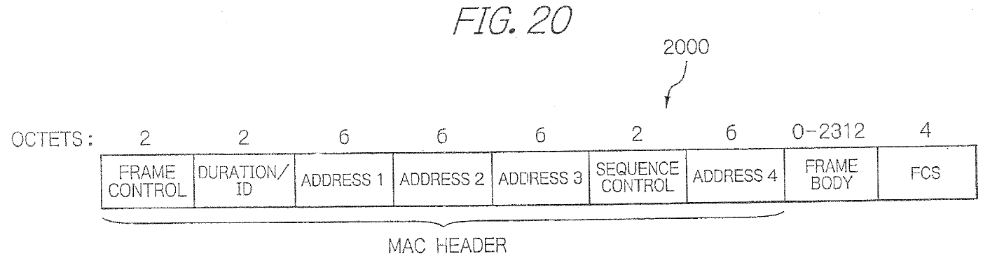

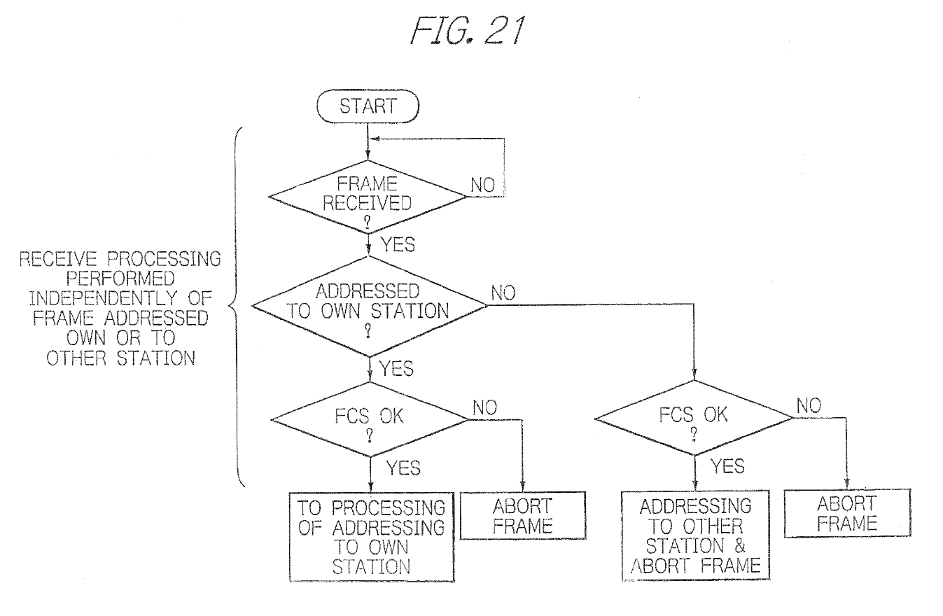

FIG. 20 shows a frame data structure or format 2000 used in a wireless LAN. FIG. 21 shows an example of receive processing taken when a frame is received.

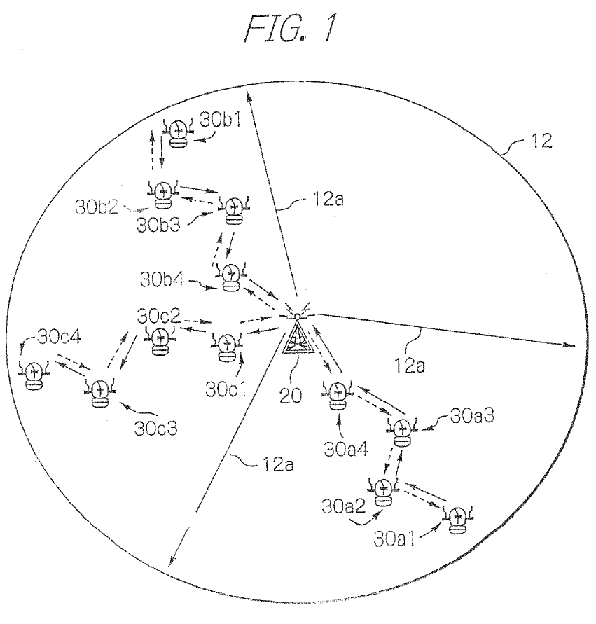

In reference to the accompanying drawings, illustrative embodiments of the present invention will be detailed below. The description below specifically refers to a case where the present invention is applied to a wireless network system in which a wireless LAN base station 20 and a plurality of wireless LAN terminal stations 30, both FIG. 1, communicate with each other in a wireless manner.

FIG. 1 shows an example of wireless network related with a first illustrative embodiment in accordance with the present invention. As shown in the figure, the wireless network includes a plurality of wireless LAN terminal stations 30a1 to 30a4, 30b1 to 30b4 and 30c1 to 30c4, which center a wireless LAN base station 20 and stay within a range 12, hereafter referred to as “wireless area”, which defines an area where a specific kind of control frame, such as a beacon frame, sent from the wireless LAN base station 20 in a wireless manner and including control information to communicate with the wireless LAN base station 20 in a wireless manner can be received. The area may be referred to as a beacon frame available range, which is depicted with the longer arrows 12a in FIG. 1. Hereinafter, when it is not necessary to specifically identify the wireless LAN terminal stations 30a1 to 30a4, 30b1 to 30b4 and 30c1 to 30c4 from each other, they are represented simply as a wireless LAN terminal station “30”.

Each wireless LAN terminal station 30 can communicate with the wireless LAN base station 20. Each wireless LAN terminal station 30 can also communicate with other wireless LAN terminal stations 30. By transferring data sequentially via other wireless LAN terminal stations 30, each wireless LAN terminal station 30 can relay a frame for multi-hop communication to and from the wireless LAN base station 20. Such relaying is referred to as routing. For example, in order to relay frames, received by a wireless LAN terminal station 30a2 from the wireless LAN terminal station 30a1, to a wireless LAN terminal station 30a3, the technology may be used which is taught by, for example, “IEEE P802.11s/D1.03 Draft STANDARD for Information Technology Telecommunications and Information exchange between systems Local and metropolitan area networks Specific requirements Part 11: Wireless LAN Media Access Control (MAC) and Physical Layer (PHY) specifications Amendment <number>: ESS Mesh Networking”, “RFC3561 Ad hoc On-Demand Distance Vector (AODV) Routing”, and “RFC3626 Optimized Link State Routing Protocol (OLSR)”. Description of the routing function mechanism is omitted since it is not involved with the nature of the present invention.

Each wireless LAN terminal station 30 stores a piece of routing information on a data transfer route for multi-hop communication with the wireless LAN base station 20. The routing information may be generated by each wireless LAN terminal station 30 and wireless LAN base station 20. Alternatively, as taught by Japanese '629 publication stated earlier, for example, a route control station is separately prepared so that routing information generated by the route control station is sent to each wireless LAN terminal station 30 and wireless LAN base station 20.

According to this illustrative embodiment, the wireless LAN terminal station 30a1 can communicate with the wireless LAN terminal station 30a2, which can in turn communicate with the wireless LAN terminal stations 30a1 and 30a3. The wireless LAN terminal station 30a3 can communicate with the wireless LAN terminal stations 30a2 and 30a4, and the wireless LAN terminal station 30a4 can communicate with the wireless LAN terminal station 30a3 and wireless LAN base station 20.

Wireless LAN terminal station 30b1 can communicate with a wireless LAN terminal station 30b2, which can in turn communicate with the wireless LAN terminal stations 30b1 and 30b3. The wireless LAN terminal station 30b3 can communicate with the wireless LAN terminal stations 30b2, 30b4, and the wireless LAN terminal station 30b4 can communicate with the wireless LAN terminal station 30b3 and the wireless LAN base station 20.

In addition, the wireless LAN terminal station 30c1 can communicate with a wireless LAN terminal station 30c2 and the wireless LAN base station 20, and the wireless LAN terminal station 30c2 can communicate with the wireless LAN terminal stations 30c1 and 30c3. The wireless LAN terminal station 30c3 can communicate with the wireless LAN terminal stations 30c2 and 30c4, and the wireless LAN terminal station 30c4 can communicate with the wireless LAN terminal station 30c3.

In FIG. 1, the shorter arrows show the direction of frame transmitted. The shorter solid arrows show send data frames, while the shorter dashed arrows show acknowledge frames.

On the other hand, the wireless LAN base station 20 sends and receives a data frame that stores sensing information, and others with the wireless LAN terminal station 30a4, wireless LAN terminal station 30b4 and wireless LAN terminal station 30c1, using unicast sending function.

The wireless LAN base station 20 can send a frame, such as beacon frame, which manages a wireless network using broadcast to all the wireless LAN terminal stations 30 at a time. The beacon frame is a broadcast frame sent from the wireless LAN base station 20 to the wireless network. It stores, as control information, information such as communication rate available within a wireless area 12 and time-stamp information for establishing time synchronization within a wireless area 12.

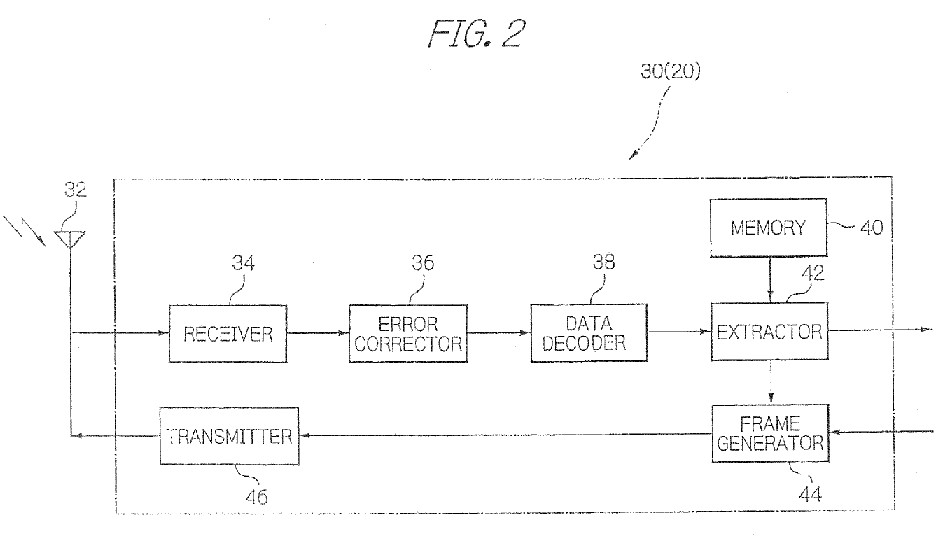

Now, FIG. 2 is a block diagram illustrating a general functional configuration of a communication interface section for communicating with the wireless LAN terminal station 30 on the wireless LAN, according to the instant illustrative embodiment. The wireless LAN terminal station 30 includes an antenna 32, a receiver 34 for receiving a frame sent via the antenna 32 from the wireless LAN base station 20 and other peripheral wireless LAN terminal station 30, an error corrector 36 for confirming the FCS of a frame received by the receiver 34 to perform an error correction, a data decoder 38 for extracting an actual data field from the frame corrected by the error corrector 36 to decode data thus received, a memory 40 for storing information on data to be received by the wireless LAN terminal station 30, an extractor 42 for extracting part of data decoded by the data decoder 38 corresponding to data specified by information stored in the data memory 40, a frame generator 44 for dividing data to be sent to produce a frame that has the divided data embedded therein, and a transmitter 46 for sending a frame specified to be sent via the antenna 32.

The memory 40 according to the instant illustrative embodiment stores information on the MAC address of the wireless LAN terminal station 30 and routing information on a transfer route for the above-mentioned multi-hop communication. The routing information may have, for example, the MAC address of each wireless LAN terminal station 30 performing multi-hop communication in the order of transfer routes. Alternatively, the routing information may have, for each wireless LAN terminal station 30, the MAC address of wireless LAN terminal stations 30 of a transfer source and a destination in the wireless LAN terminal station 30 in question.

The extractor 42 references the MAC header address of data decoded by the data decoder 38, and extracts data addressed to the own station and a broadcast address frame to output them to a control section, not shown, such as an OS (Operating System). It also extracts data sent from a transfer source in this wireless LAM terminal station 30 in question on a transfer route designated by routing information to output it to the frame generator 44. By so doing, data sent from the transfer source is again divided by the frame generator 44 to produce a frame. The transmitter 46 sends via the antenna 32 a frame thus produced by the frame generator 44.

On the other hand, the communication interface section of the wireless LAN base station 20 according to the instant illustrative embodiment also has almost the same configuration as the communication interface section of the wireless LAN terminal station 30 shown in FIG. 2. The memory 40 stores routing information including information such as the MAC address of each wireless LAN terminal station 30 in order to perform multi-hop communication.

Described below will be the operation of the wireless network according to the instant illustrative embodiment. In this embodiment, as shown in FIG. 1, the wireless LAN terminal stations 30a1, 30a2, 30a3 and 30a4 perform multi-hop communication to communicate with the wireless LAN base station 20, the wireless LAN terminal stations 30b1, 30b2, 30b3 and 30b4 perform multi-hop communication to communicate with the wireless LAN base station 20, and the wireless LAN terminal stations 30c1, 30c2, 30c3 and 30c4 perform multi-hop communication to communicate with the wireless LAN base station 20.

The wireless LAN terminal station 30a1 according to the instant illustrative embodiment sends frames to the wireless LAN terminal station 30a2, those frames including one addressed to wireless LAN base station 20, one addressed to another wireless LAN terminal station 30 residing within the same wireless network and via the via wireless LAN base station 20, and one addressed to the wireless LAN terminal station 30 residing in another wireless network via the via wireless LAN base station 20.

The wireless LAN terminal station 30a2 relays a frame received from the wireless LAN terminal station 30a1 to the wireless LAN terminal station 30a3, which in turn relays a frame received from the wireless LAN terminal station 30a2 to the wireless LAN terminal station 30a4, which in turn relays a frame received from the wireless LAN terminal station 30a3 to a wireless LAN base station 20.

The wireless LAN base station 20 completes a communication if a frame received from the wireless LAN terminal station 30a4 is addressed to a wireless LAM base station 20. Alternatively, if this frame is addressed to another wireless LAN terminal station 30, for example, wireless LAN terminal station 30c2, residing within the same wireless network, it is relayed from the wireless LAN base station 20 to the wireless LAN terminal station 30c1, from which to wireless LAN terminal station 30c2, thereby the communication being completed. Alternatively, if this frame is addressed to a wireless LAN terminal station 30 residing in another wireless network, the wireless LAN base station 20 uses a backbone network to relay it to the other wireless LAN base station 20.

By transferring data with multi-hop communication as mentioned above, for example, a data frame is successfully sent by the wireless LAN terminal station 30a1 if received by the wireless LAN terminal station 30a2, and an acknowledge frame is successfully returned from the wireless LAN terminal station 30a2 if received by the wireless LAN terminal station 30a1.

In this way, the wireless LAN terminal station 30a1 can send a frame to the wireless LAN terminal station 30a2 with less transmission power than that for sending it to the wireless LAN base station 20, namely, consuming the power required only for sending a frame to the wireless LAN terminal station 30a2. The same condition may also be applied to an acknowledge frame sent by the wireless LAN terminal station 30a2.

A frame sent between the terminal station and base station such as the wireless LAN terminal stations 30b1, 30b2, 30b3 and 30b4 and the wireless LAN base station 20 also uses the same multi-hop communication as described above.

FIG. 1 also shows a frame sent from the wireless LAN base station 20 to the wireless LAN terminal station 30c4. The wireless LAN base station 20 sends a frame addressed to the wireless LAN terminal station 30c4 via relay stations such as the wireless LAN terminal stations 30c1, 30c2 and 30c3 according to the same relaying method as described above.

In operation described above, the wireless LAN base station 20 can send a frame to the wireless LAN terminal station 30c1 with less transmission power than normally required, in other words, consuming the power required only for sending a frame to the wireless LAN terminal station 30C1. The same condition may also be applied to an acknowledge frame sent by the wireless LAN terminal station 30c1.

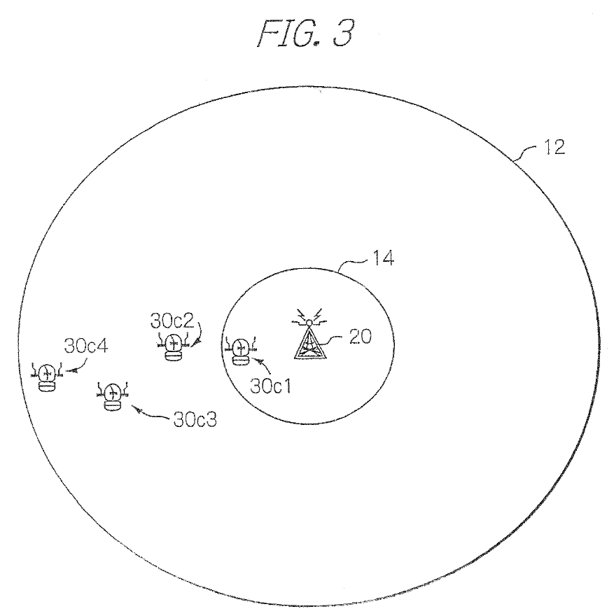

FIG. 3 shows a communication available range 14 in which the wireless LAN base station 20 can successfully send a frame with a transmission power needed to send the frame to the wireless LAN terminal station 30c1.

On the other hand, the wireless LAN base station 20 sends a frame, such as a beacon frame addressed to all wireless LAN terminal stations 30, using, rather than multi-hop communication, a broadcast delivery to all wireless LAN terminal stations 30, unlike a frame meant for the wireless LAN terminal station 30c4. A beacon frame in the wireless LAN stores information such as a communication rate available within the wireless area 12 and time stamp information with which time-synchronization is established in the wireless area 12. That information is required by all wireless LAN terminals. For this purpose, the wireless LAN base station 20 broadcasts information to all wireless LAN terminal stations 30 residing in the wireless network. In such a manner, a send frame addressed via broadcast and multicast does not use multi-hop communication but is collectively delivered at a time.

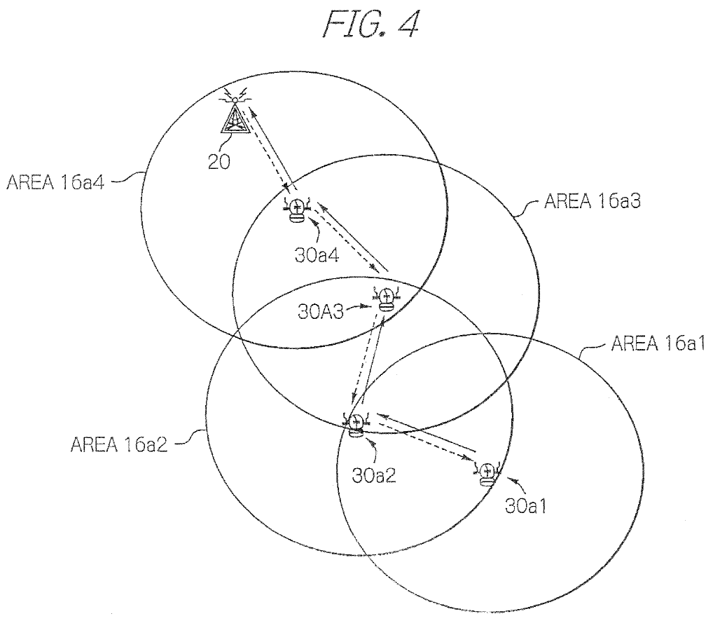

FIG. 4 is an expanded diagram of the part shown in FIG. 1. A area 16a1 is a range within which a transmission radio wave from the wireless LAN terminal station 30a1 is available.

In the conventional wireless network system, as shown in FIG. 19, the wireless LAN terminal station 1900, needing to send a frame to the wireless LAN base station 1700, must increase its transmission power enough to emit a transmission radio wave over the area 1910.

By contrast, for multi-hop communication as shown in FIG. 4, the wireless LAN terminal station 30a1 may only send a frame to the wireless LAN terminal station 30a2 using such a smaller transmission power which is sufficient for delivering a signal throughout the area 16a1, resulting in significantly saving the power of its battery.

By thus narrowing the communication area, i.e. short-distance area, according to the instant illustrative embodiment, the wireless communication stability increases, thus accomplishing a higher rate transmission, which shortens the transmission period of time and reduces a retransmission count thanks to the improved reception probability, also resulting in significantly saving the battery power.

By rendering the communication area thus smaller according to the instant illustrative embodiment, even while the wireless LAN terminal station 30a1 is sending a frame and the wireless LAN terminal station 30a2 is returning an acknowledge frame, within the range except the areas 16a1 and 16a2, communication is permitted so as to utilize the bandwidth in the wireless network.

As described above, narrowing communication area allows the wireless LAN terminal stations 30a1 to 30a4, as shown in FIG. 4, to ignore communication between the wireless LAN terminal stations 30b1 to 30b4 and between wireless LAN terminal stations 30c1 to 30c4, without receiving frames addressed to other stations, resulting also in significantly saving the battery power.

By a simultaneous broadcast delivery, such as broadcast or multicast, of a frame addressed in group, the device in the wireless LAN base station 20 can save a communication period of time and bandwidth in the wireless network compared with multicast transmission.

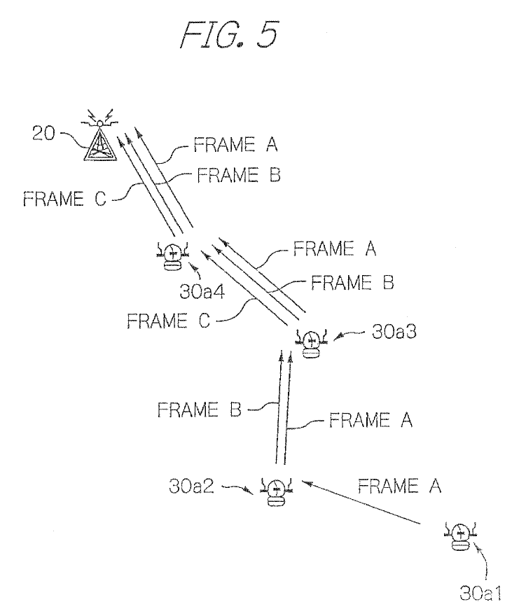

In the first embodiment, each of the wireless LAN terminal stations 30 performs multi-hop communication by transferring a frame each on a transfer route. FIG. 5 shows the wireless LAN terminal stations 30a1, 30a2, 30a3 and 30a4 and the wireless LAN base station 20, according to the first embodiment shown in FIG. 4.

More specifically, the wireless LAN terminal station 30a1 sends a frame A to the wireless LAN terminal station 30a2, which in turn transfers the frame A received from the wireless LAN terminal station 30a1 to a wireless LAN terminal station 30a3 while it sends its own frame B to the wireless LAN terminal station 30a3 at a time. The wireless LAN terminal station 30a3 in turn transfers the frames A and B received from the wireless LAN terminal station 30a2 to a wireless LAN terminal station 30a4, while it sends its own frame C to the wireless LAN terminal station 30a4 at a time. The wireless LAN terminal station 30a4 sends the frames A, B and C to the wireless LAN base station 20.

As mentioned above, in the first embodiment, when the wireless LAN terminal station 30 stays closer to the wireless LAN base station 20, its frame transmission frequency becomes higher and accordingly its power consumption increases.

Thus, an alternative embodiment will be described below in which the wireless LAN terminal station 30, even when residing closer to the wireless LAN base station 20, can still prevent its power consumption from increasing. The wireless network configuration according to the alternative, second embodiment may be almost the same as the first embodiment shown n and described with reference to FIG. 1, so that its detailed description will not be repeated. Also, the configuration of the communication control section for the wireless LAN in the wireless LAN terminal station 30 according to the second embodiment may be almost the same as the first embodiment shown in and described with reference to FIG. 2, except that ones of the frames to be transmitted by the transmitter 46 to the wireless LAN base station 20 or other wireless LAN terminal stations 30 and having the address thereof common to each other are aggregated to be sent via the antenna 32.

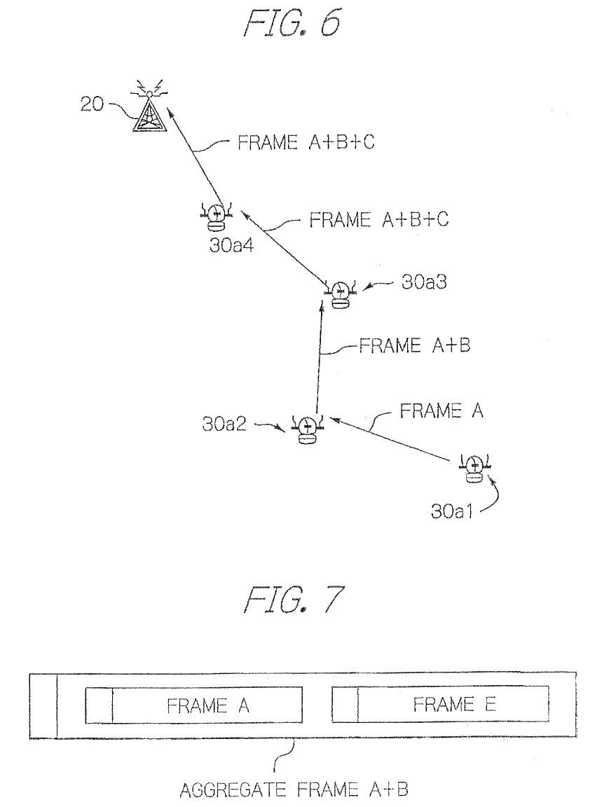

FIG. 6 shows an exemplified operation of the wireless network according to the second embodiment. The wireless LAN terminal station 30a1 sends a frame A to a wireless LAN terminal station 30a2, which in turn aggregates the frame A received from the wireless LAN terminal station 30a1 with its own frame B to send the frames thus aggregated in the form of single frame A+B including the frames A and B to a wireless LAN terminal station 30a3.

The wireless LAN terminal station 30a3 aggregates the frame A+B received from the wireless LAN terminal station 30a2 with its own frame C to send the latter also in the form of single frame A+B+C to a wireless LAN terminal station 30a4, which will then send the frame A+B+C received from the wireless LAN terminal station 30a3 without any modification, in this example, to the wireless LAN base station 20.

As shown in FIG. 6, the frame A sent from the wireless LAN terminal station 30a1 is delivered with multi-hop. The wireless LAN terminal station 30a2 that received the frame A aggregates the frame A with the frame B, which it holds and wants to send, to make another frame A+B and send the latter for relaying.

FIG. 7 shows an example of the data structure of the aggregate frame A+B. The wireless LAN terminal station 30a3 that received the frame A+B aggregates the frame A+B with the frame C, which it holds and wishes to send, to produce another frame A+B+C and send it for relaying.

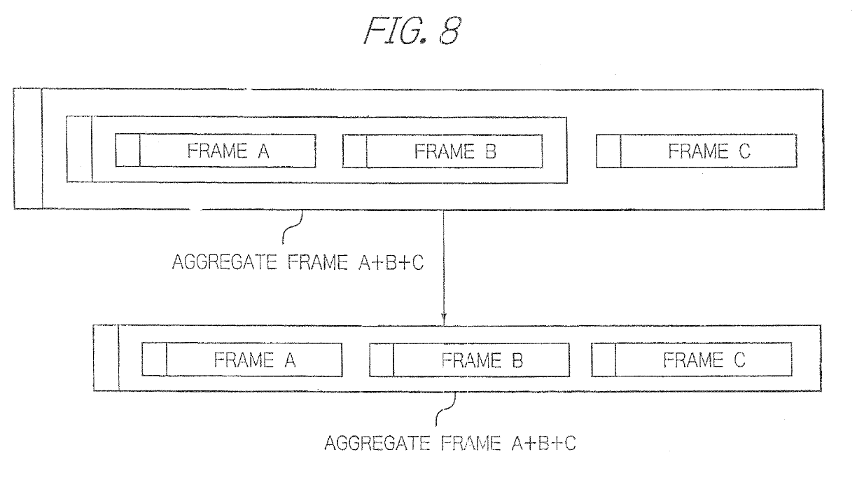

FIG. 8 shows an example of the data structure of the aggregate frame A+B+C. To such frame aggregating, any type of technology for combining frames may be applied, which is taught by, for example, “IEEE P802.11n/D2.00 Draft STANDARD for Information Technology Telecommunication and Information exchange Between systems Local and metropolitan area networks Specific requirements Part 11: Wireless LAN Media Access Control (MAC) and Physical Layer (PHY) specification: Amendment <number>: Enhancements for Higher Throughput”. This frame aggregating function mechanism is not relevant to understanding the nature of the present invention, thus its description being omitted here.

The wireless LAN terminal station 30a4 that received the frame A+B+C sends, i.e. relays, the frame as it is to the wireless LAN base station 20.

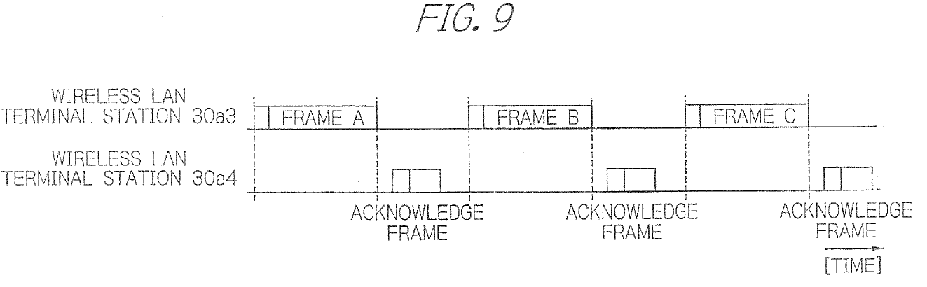

FIG. 9 shows a frame transfer sequence in which the wireless LAN terminal station 30a3 sends each of frames A, B and C separately from each other without aggregating them into one, and an acknowledge frame is returned from the wireless LAN terminal station 30a4 for confirming the reception of frames A, B and C.

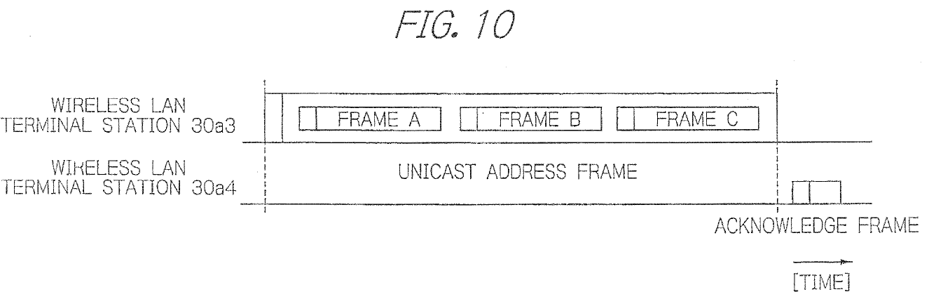

FIG. 10 shows another frame transfer sequence in which the wireless LAN terminal station 30a3 sends the frame A+B+C, which is produced by aggregating the frames A, B and C, and an acknowledge frame is returned from the wireless LAN terminal station 30a4 for confirming the reception of the frame A+B+C. In FIG. 10, the wireless LAN terminal stations 30a3 and 30a4 are depicted as an example. The same condition may be applied in between to the wireless LAN terminal stations 30a2 and 30a3, and also in between to the wireless LAN terminal station 30a4 and wireless LAN base station 20.

During multi-hop communication, each wireless LAN terminal station 30 aggregates a frame, which it wants to send, with a transferred frame to produce one frame and send it, resulting in a decrease of the number of frames communicated between the wireless LAN terminal stations 30, especially in a reduction of the battery power consumption which would otherwise be caused by acknowledge frame transmission and reception processing, as well as saving the bandwidth in the wireless network.

The second embodiment described above is directed to the wireless LAN terminal station 30 combining a plurality of frames to send a resultant frame. Now, a still alternative, third embodiment will be described in which the wireless LAN base station 20 is adapted to combine frames addressed to a specific wireless LAN terminal station 30 into one frame, and transmits the latter frame. The configuration of the wireless network according to the third embodiment may be the same as the first embodiment shown in and described with reference to FIG. 1, and its repetitive description is omitted here.

According to the third embodiment, a plurality Of wireless LAN terminal stations 30 are grouped into several groups each of which includes a specific or predetermined number of LAN terminal stations. The wireless LAN base station 20 is adapted to combine frames which are to be sent to the wireless LAN terminal stations 30 belonging to specific one of the groups into a single frame, which will be transmitted to the LAN terminals included in that group.

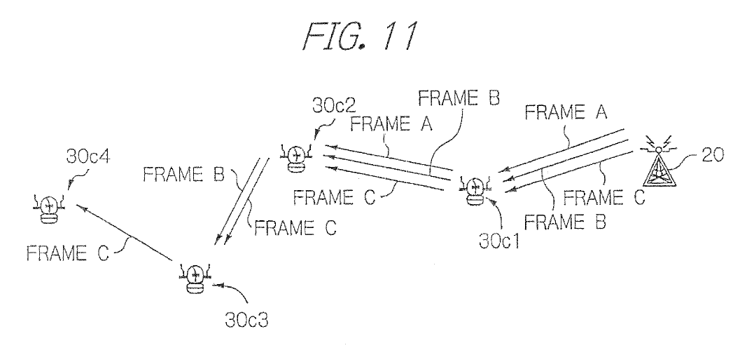

Now, reference will be made to FIG. 11 which shows the wireless LAN base station 20, and the wireless LAN terminal stations 30c1, 30c2, 30c3 and 30c4, which may be those shown in FIG. 4 according to the first embodiment. The wireless LAN base station 20 sends a frame A addressed to the wireless LAN terminal station 30c2 via the wireless LAN terminal station 30c1. Similarly, the wireless LAN base station 20 sends a frame B addressed to the wireless LAN terminal station 30c3 via the wireless LAN terminal stations 30c1 and 30c2, and sends a frame C addressed to the wireless LAN terminal station 30c4 via the wireless LAN terminal stations 30c1, 30c2 and 30c3.

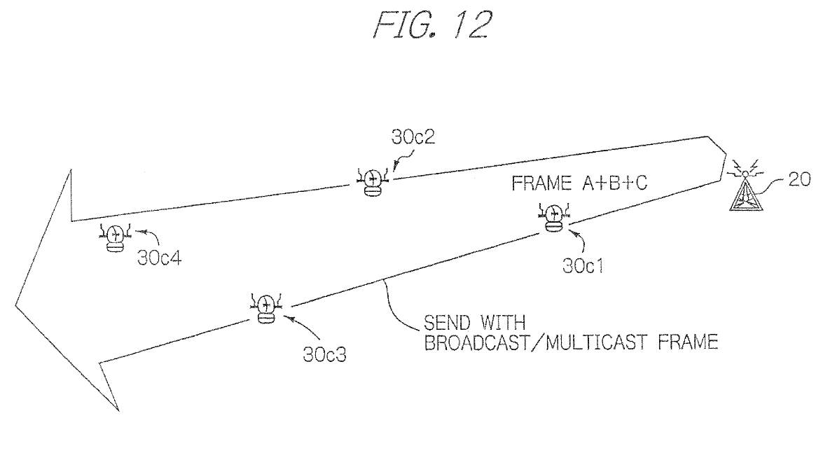

FIG. 12 shows an example of the operation of the wireless network according to the third embodiment. The wireless LAN base station 20 aggregates the frames A, B and C addressed to the wireless LAN terminal stations 30c2, 30c3 and 30c4, respectively, into one frame A+B+C, which will be sent on broadcast or multicast. In the application, the addresses on broadcast and multicast are generically referred to as a group address.

In FIG. 12, the wireless LAN base station 20 holds the frames A, B and C addressed to the wireless LAN terminal stations 30c2, 30c3 and 30c4, respectively, to be sent as a frame. The wireless LAN base station 20 aggregates the frames A, B and C having the address thereof different from each other into one frame A+B+C, which will be transmitted. The address of the aggregated frame is a broadcast or multicast address for a group containing the wireless LAN terminal stations 30c2, 30c3 and 30c4.

The frame sent with its group address contains address information on the wireless LAN terminal station 30 to which the frames A, B and C are to be destined as well as on the length of the frames included therein as aggregation information. Each wireless LAN terminal station 30 can disaggregate one or ones of the frames which is/are addressed to that station. One or ones of the frames which is/are not meant for that station but to be destined to other stations may be aborted or destroyed. Such frame aggregating mechanism may be the same as in FIGS. 7 and 8. For example, as described earlier, the technology available therefor may be one taught by “IEEE P802.11n/D2.00 Draft STANDARD for Information Technology Telecommunications and Information exchange between systems Local and metropolitan area networks Specific requirements Part 11: Wireless LAN Medium Access Control (MAC) and Physical Layer (PHY) specifications: Amendment <number>: Enhancements for Higher Throughput”. Such frame aggregating function mechanism is not involved with understanding the present invention, thus its description be in omitted here.

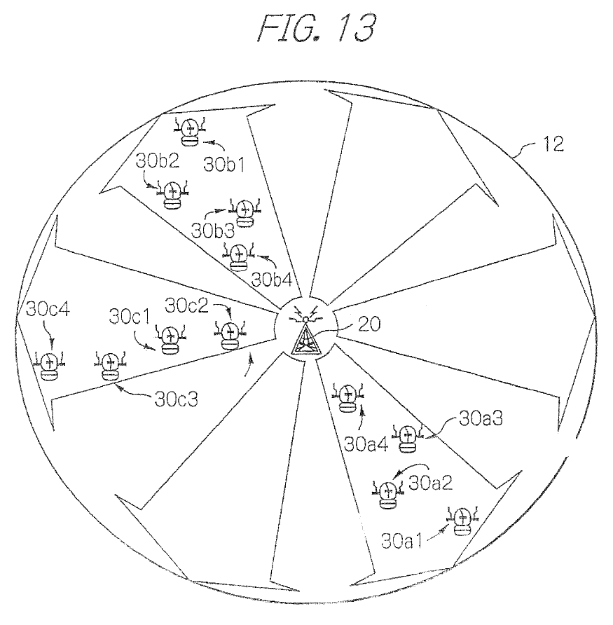

Reference will be made to FIG. 13, the arrows show the groups of wireless LAN terminal stations 30, each of the groups being established so as to transmit an aggregate frame A+B+C having the same group address. The frame A+B+C sent with a group address is to be received by all wireless LAN terminal stations 30 belonging to the wireless area 12. As described above, the aggregate frame contains address information on frames A, B and C so that each station can determine whether or not the frames contained are to be addressed to itself.

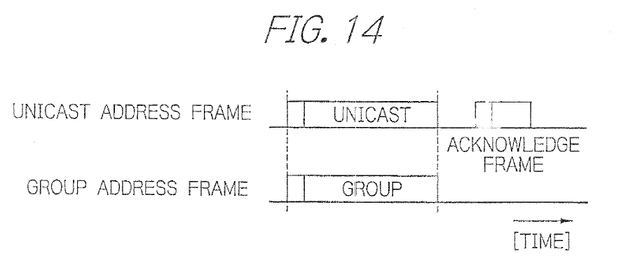

FIG. 14 shows a frame transfer sequence in which the wireless LAN terminal station 30 receives a unicast frame and a group address frame. In reply to the unicast frame, an acknowledge frame is returned with which the wireless LAN terminal station 30 confirms a reception of the unicast frame. However, to the group address frame, an acknowledge frame will not be returned for confirmation.

Consequently, the wireless LAN terminal station 30 needs not to return an acknowledge frame in response to an aggregate frame received from the wireless LAN base station 20. Alternatively, the embodiment may of course be adapted to return an acknowledge frame in response to an aggregate frame.

A mechanism to return no acknowledge frame in response to a group address frame may be one defined by a standard of the wireless LAN technology disclosed by, for example, “ANSI/IEEE Std 802.11, 1999 Edition Wireless LAN Medium Access Control (MAC) and Physical Layer (PHY) Specifications”. That is, when the wireless LAN terminal station 30 sends the frames A, B and C separately from each other in the form of unicast frame, an acknowledge frame is returned to confirm the reception of each frame.

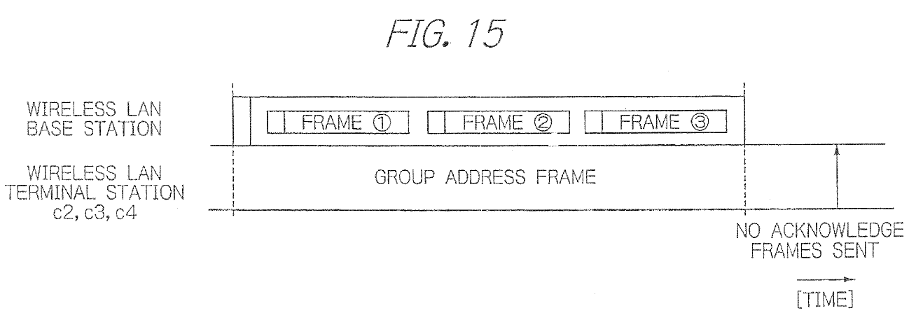

By contrast, in the case as shown in FIG. 15, when the wireless LAN terminal station 30 aggregates three frames A, B and C having the address thereof different from each other to generate one group address frame and to send the latter frame, no acknowledge frame is returned for confirmation. In the above operation, the number of frames transferred between the wireless LAN terminal stations 30 decreases, and especially the battery power consumption reduces due to removing acknowledge frame transmission and reception. In addition, bandwidth in the wireless network can be saved.

Sending an aggregate frame attached with a group address causes, as seen from FIG. 13, the wireless LAN terminal station 30 not involved in that address to receive the frame. However, in the wireless LAN communication, analyzing a frame not addressed to its own station has conventionally be done, thus needing no more power consumed than before.

A still further alternative, fourth embodiment will be described. The wireless network configuration according to the fourth embodiment may be the same as the first embodiment shown in and described with reference to FIG. 1, and its repetitive description is omitted here. The communication control section for controlling the wireless LAN of the wireless LAN terminal stations 30 according to the fourth embodiment may be almost the same in configuration as the first embodiment shown in FIG. 1, except that the transmitter 46 adjusts its transmission power according to the communication condition so that, when no wireless LAN base station 20 and other wireless LAM terminal stations 30 which are available in communication, the transmission power is temporarily rendered increased.

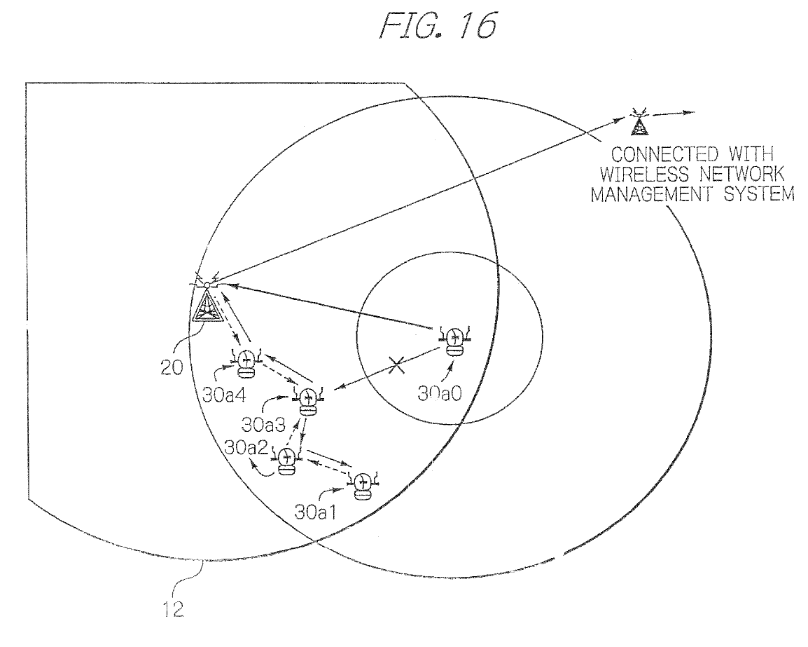

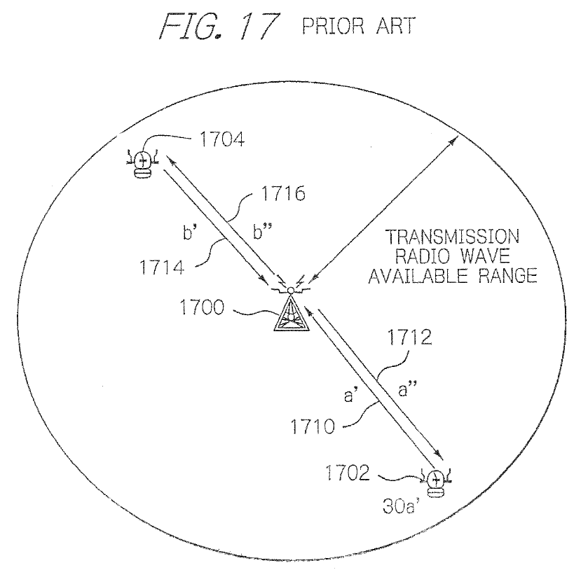

FIG. 16 shows an example of the operation of the wireless network according to the fourth embodiment. As seen from the figure, there is a wireless network which centers the wireless LAN base station 20 and has its wireless area 12 covering the wireless LAN terminal stations 30a0, 30a1, 30a2, 30a3 and 30a4.

The wireless LAN terminal stations 30a0, 30a1, 30a2, 30a3 and 30a4 may be of the first or second embodiment described earlier and adapted to transmit a frame to the wireless LAN base station 20 on multi-hop communication.

The wireless LAN base station 20 may be of the first or third embodiment adapted to send a frame to the wireless LAN terminal station 30 with multi-hop or aggregating frames with a broadcast of multicast address attached thereto.

The wireless LAN terminal stations 30a1, 30a2, 30a3 and 30a4 are in a condition where another terminal station resides within their communication avail able range and a frame may be transmitted on multi-hop.

The wireless LAN terminal station 30a0 is however in a condition where no terminal stations reside within its communication available range and the multi-hop transmission of frames is not available. It can be determined that the wireless LAN terminal station 30a0 fails to send frames over multi-hop by failing, for example, to receive an acknowledge frame being returned in response to a send frame, or to monitor frames transferred between other terminal stations. However, such determination per se is not relevant to understanding the nature of the present invention so that its description is omitted here.

Under the circumstances, the wireless LAN terminal station 30a0 increases its transmission power to expand the radio wave available area, i.e. communication available range, to thereby shift itself to the state where communication is available with the wireless LAN base station 20 and other wireless LAN terminal station 30, and send a control frame as an alarm notice indicating that currently no communication is available.

The wireless LAN terminal station 30a0 thus does not increase its transmission power to send a data frame but a control frame because, if the power increases every time a data frame is sent, then the battery would consume itself rapidly and additionally the wireless LAN base station 20 and wireless LAN terminal station 30 would, when received a data frame, also need to increase its power to send an acknowledge frame, thereby also consuming the battery.

In order to send a control frame to the wireless LAN base station 20, the wireless LAN terminal station 30a0 has to learn the address of the wireless LAN base station 20. A possible method of knowing that address may be of receiving a beacon frame, which the wireless LAN base station 20 constantly transmits in the wireless area 12, by the wireless LAN terminal station 30a0 to store it.

The wireless LAN terminal station 30a0 is however unable to receive a frame from other wireless LAN terminal stations 30, and thus fails to know its address. Therefore, in order to send a control frame to other wireless LAN terminal stations 30, the wireless LAN terminal station 30a0 may use, for example, a broadcast frame. Other wireless LAN terminal stations 30, when received the broadcast control frame, may transfer the frame to the wireless LAN base station 20 with multi-hop operation to notify the wireless LAN base station 20 of the state of the wireless LAN terminal station 30a0.

Thus, the wireless LAN terminal station 30, if no communication available wireless LAN base station 20 and other wireless LAN terminal station 30 are present, may temporarily increase the transmission power to send a frame indicating its status to the wireless LAN base station 20 and other wireless LAN terminal stations 30, located at slightly apart, thereby presenting an alarm to the network management system and others so that the network administrator can change the position of the wireless LAN terminal station 30 in question or increase the wireless LAN terminal stations 30 which relay the frames.

The first embodiment is directed to both communications from the wireless LAN terminal station 30 and wireless LAN base station 20 operating on multi-hop transmission. Alternatively, the wireless LAN terminal station 30 may be adapted to communicate with the wireless LAN base station 20 on multi-hopping, while the wireless LAN base station 20 may communicate with the wireless LAN terminal station 30 on a direct connection to the destination terminal station. More specifically, for example, not with the third embodiment aggregating frames with a group address to send them, a single frame may be transmitted alone via unicast, or frames with the same address may be combined into one which will be sent via unicast.

The above-described embodiments are directed to the wireless LAN, taken as an example of wireless communication, including the wireless LAN base station 20 and wireless LAN terminal station 30. The present invention is, however, not specifically limited to such examples. In addition, the configuration of the wireless LAN base station 20 in the illustrative embodiments specifically described with reference to FIG. 2 is a mere example, and, needless to say, can appropriately be modified within the scope and spirit of the invention.

The entire disclosure of Japanese patent application No. 2008-002200 filed on Jan. 9, 2008 including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A wireless terminal device comprising:
a memory for storing routing information on a transfer route for multi-hop communication with a communication target wireless base station and transmitted in a wireless manner from the wireless base station by sequentially transferring data between a plurality of adjacent wireless terminal devices belonging to a receivable range of a control frame containing control information for wireless communication with the wireless base station;
a receiver for receiving a frame sent from the wireless base station and another wireless terminal device in the wireless manner; and
a transmitter for sending first one of the frames received by said receiver on the transfer route indicated by the routing information stored by said memory to a transfer destination, the first frame being sent from the wireless terminal device operative as a transfer source.

2. The wireless terminal device according to claim 1, further comprising:
a generator for generating a frame to be transmitted to the wireless base station or the other wireless terminal device; and
an aggregation circuit for aggregating the generated frame to second one of the frames received by said receiver to produce an aggregate frame, the second frame having a same address as the frame generated by said generator,
said transmitter transmitting the aggregate frame to the transfer destination.

3. The wireless terminal device according to claim 1, further comprising a determiner for using a signal length of the frame received from the other wireless terminal device by said receiver to determine whether or not there is any other wireless terminal device in neighborhood,
said transmitter increases the transmission power if said determiner determines that there is no other wireless terminal device in the neighborhood.

4. A wireless base station device comprising:
a memory for storing routing information on a transfer route for multi-hop communication with said wireless base station and transmitted in a wireless manner by sequentially transferring data between a plurality of adjacent wireless terminal devices belonging to a receivable range of a control frame containing control information for wireless communication with said wireless base station;
a receiver for receiving a frame sent in the wireless manner from the wireless terminal device;
a communication circuit connected to a backbone network for transmitting or receiving data to or from the backbone network; and
a transmitter for sending first one of the frames received by said receiver and via said communication circuit on the transfer route indicated by the routing information stored in said memory to a transfer destination, the first frame having an address of another wireless terminal device, the transfer destination including a wireless terminal device specified by the address.

5. The wireless base station device according to claim 4, further comprising an aggregation circuit for aggregating a plurality of frames to be sent on a same transfer route to produce an aggregate frame, said transmitter transmitting the aggregate frame to the transfer destination.

6. The wireless base station device according to claim 5, wherein said transmitter sends the aggregate frame directly to the wireless terminal device on the transfer route of the transfer destination.

7. The wireless base station device according to claim 6, wherein said transmitter sends the aggregate frame on a broadcast frame or multicast frame to the wireless terminal device on the transfer route of the transfer destination.

8. The wireless base station device according to claim 5, wherein said aggregation circuit combines a plurality of frames having a same address.

9. The wireless base station device according to claim 8, wherein said transmitter sends the aggregate frame on a unicast frame to the wireless terminal device of the transfer destination.
